(19) United States
(12) Patent Application Publication
(10) Pub. No.: US 2026/0280673 A1
(43) Pub. Date: Sep. 17, 2026

(54) EVENT TRIGGERED BEAM REPORTING METHODS AND APPARATUS

(71) Applicant: ZTE Corporation, Shenzhen (CN)

(72) Inventors: Wenfeng LIU, Shenzhen (CN); Bo GAO, Shenzhen (CN); Zhaohua LU, Shenzhen (CN); Ke YAO, Shenzhen (CN); Ling YANG, Shenzhen (CN); Yang ZHANG, Shenzhen (CN)

(21) Appl. No.: 19/678,010

(22) Filed: May 14, 2026

Related U.S. Application Data
(63) Continuation of application No. PCT/CN2023/135135, filed on Nov. 29, 2023.

(51) Int. Cl. H04B 7/06; H04W 24/10; H04W 72/044; H04W 72/542

(52) U.S. Cl. CPC H04B 7/06958; H04W 24/10; H04W 72/046; H04W 72/542

(57) ABSTRACT

Methods, system and apparatus for wireless communication are described. A wireless communication method includes determining, by a wireless device, based on a rule, whether an event for beam reporting has occurred. Upon determining that the event for beam reporting has occurred, the wireless device triggers a beam report transmission from the wireless device to a network device.

### CROSS-REFERENCE TO RELATED APPLICATIONS

This application is a continuation of International Patent Application No. PCT/CN2023/135135, filed on Nov. 29, 2023, the contents of which are incorporated herein by reference in their entirety.

### TECHNICAL FIELD

This patent document relates to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques for beam management.

In one aspect, a method of wireless communication is disclosed. The method includes determining, by a wireless device, based on a rule, whether an event for beam reporting has occurred, and triggering, upon determining that the event for beam reporting has occurred, a beam report transmission from the wireless device to a network device.

In another aspect, a method of wireless communication performed by a network device is disclosed. The method includes receiving, by a network device, a beam report transmission from a wireless device, wherein the beam report is determined by the wireless device based on a rule by determining whether an event for beam reporting has occurred, and performing further wireless communication operation based on the beam report received from the wireless device.

In another example aspect, a wireless communication apparatus comprising a processor configured to implement an above-described method is disclosed.

In another example aspect, a computer storage medium having code for implementing, by one or more processors, an above-described method stored thereon is disclosed.

These, and other, aspects are described in the present document.

### BRIEF DESCRIPTION OF THE DRAWING

FIG. 1 shows an example of a wireless communication system based on some example embodiments of the disclosed technology.

FIG. 2 is a block diagram representation of a portion of an apparatus based on some embodiments of the disclosed technology.

FIG. 3 is a block diagram of an example of event based triggering embodiment.

FIG. 4 is a block diagram of an example of event based triggering embodiment

FIG. 5 is a flowchart of an example method of wireless communication.

FIG. 6 is a flowchart of an example method of wireless communication.

### DETAILED DESCRIPTION

Section headings are used in the present document only for ease of understanding and do not limit scope of the embodiments to the section in which they are described. Furthermore, while embodiments are described with reference to 5G examples, the disclosed techniques may be applied to wireless systems that use protocols other than 5G or third generation partnership project (3GPP) protocols.

In some embodiments, a “beam state” may be equivalent to quasi-co-location (QCL) state, transmission configuration indicator (TCI) state, spatial relation (also called as spatial relation information), reference signal (RS), spatial filter or pre-coding. In some embodiments, a “beam state” may be simply called a “beam.” Specifically:
(1) in various embodiments, a “Tx beam” may be equivalent to QCL state, TCI state, spatial relation state, DL/UL reference signal (such as channel state information reference signal (CSI-RS), synchronization signal block (SSB) (which is also called as SS/PBCH), demodulation reference signal (DMRS), sounding reference signal (SRS), and physical random access channel (PRACH)), Tx spatial filter or Tx precoding;
(2) in some embodiments, an “Rx beam” may be equivalent to QCL state, TCI state, spatial relation state, spatial filter, Rx spatial filter or Rx precoding;
(3) in some embodiments, a “beam ID” may be equivalent to QCL state index, TCI state index, spatial relation state index, reference signal index, spatial filter index or precoding index.

In some embodiments, the spatial filter can be either UE-side or gNB-side one, and the spatial filter is also called as spatial-domain filter.

In some embodiments, “spatial relation information” is comprised of one or more reference RSs, which is used to represent the same or quasi-co “spatial relation” between targeted “RS or channel” and the one or more reference RSs. In some embodiments, a “beam state” is associated with or comprised of, one or more reference RSs and/or their corresponding QCL type parameters, where QCL type parameters include at least one of the following aspect or combination: [1] Doppler spread, [2] Doppler shift, [3] delay spread, [4] average delay, [5] average gain, and [6] Spatial parameter. In some embodiments, a “TCI state” is equivalent to “beam state”. In some embodiments, a ‘spatial parameter’ is equivalent to spatial parameter, a spatial Rx parameter or a spatial filter. In this patent, there are the following definitions for ‘QCL-TypeA’, ‘QCL-TypeB’, ‘QCL-TypeC’, and ‘QCL-TypeD’.
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

In various embodiments, a “UL channel” can be PUCCH or PUSCH.

In various embodiments, a “DL channel” can be PDCCH, or PDSCH.

In various embodiments, a “UL RS” can be SRS, PRACH, DMRS (e.g., DMRS for PUSCH or PUCCH).

In various embodiments, a “DL RS” can be SSB, CSI-RS, DMRS (e.g., DMRS for PDSCH, or PDCCH).

In various embodiments, a “UL signal” can be UL channel or UL RS (e.g., SRS, PRACH, DMRS, PUSCH or PUCCH).

In various embodiments, a “DL signal” can be DL channel or DL RS (SSB, CSI-RS, DMRS, PDSCH, or PDCCH).

In various embodiments, “time unit” can be sub-symbol, symbol, slot, sub-frame, frame, or transmission occasion.

In various embodiments, the power control parameter includes target power (also called as P0), path loss RS, scaling factor for path loss (also called as alpha), or closed loop process. The path-loss can be couple loss.

In various embodiments, “DCI” is equivalent to “PDCCH”.

In various embodiments, ‘precoding information’ is equivalent to a PMI, TPMI, precoding or beam.

In various embodiments, ‘TRP’ is equivalent to a RS port, a RS port group, RS resource, or a RS resource set.

In some embodiments, ‘port group’ is equivalent to antenna group, or UE port group.

The following abbreviations are used in the present document.

| Acronym | Full Name |
|---|---|
| BLER | Block error rate |
| RS | Reference signal |
| CSI-RS | Channel state information reference signal |
| CSI-IM | Channel state information interference measurement |
| SRS | Sounding reference signal |
| SS | Synchronization signal |
| PBCH | Physical broadcast channel |
| RSRP | Reference signal receiving power |
| SINR | Signal to interference plus noise ratio |
| PDCCH | Physical downlink control channel |
| PDSCH | Physical downlink sharing channel |
| QCL | Quasi co-location |
| TCI | Transmission configuration indicator |
| RRC | Radio resource control |
| MAC CE | Medium access control - control element |
| DCI | Downlink Control Information |

Various embodiments are disclosed in the following captioned sections. Although disclosed as separate embodiments, it will be understood that the techniques described in one embodiment may also be used with other techniques described in another embodiment. The headings about embodiments are simply to improve readability and not for limiting scope of the technology.

New Radio (NR) is a new radio access technology developed by 3rd Generation Partnership Project (3GPP) as a standard for air interfaces in radio networks. One of the key features of NR is the support of high frequency bands. High frequency bands have abundant frequency-domain resources, but wireless signals in high frequency bands decay quickly, which significantly limits the coverage of the wireless signals operating in those bands. To mitigate these adverse effects, transmitting signals in a beam mode that is able to concentrate energy in a relatively small spatial range is implemented, which improves the coverage in the high frequency bands. Both users and base stations need to adjust their beams and achieve precise alignment during initial access and data transmission to ensure maximum gain. 3GPP has developed a set of beam management procedures for adjusting the beam direction in the high frequency band and maintaining a suitable transmitting and receiving beam pair, including beam sweeping, beam measurement, beam reporting, and beam indication.

In the current specification, the UE is configured with at least one resource settings for channel measurement and at least one reporting settings for CSI report. Each reporting setting contains the parameters for one CSI reporting band and the CSI related quantities to be reported by the UE. For beam management, the CSI related quantities to be reported by the UE mainly include CSI-RS resource indicator (CRI), SS/PBCH Block resource indicator (SSBRI), L1-RSRP or L1-SINR. More specifically, a higher layer parameter for report quantity configuration can be set to ‘cri-RSRP’, ‘cri-SINR’, ‘ssb-Index-RSRP’, and ‘ssb-Index-SINR’. For example, if the higher layer parameter is set to ‘cri-RSRP’, the UE shall report one or multiple CRI and associated L1-RSRP in a single report for each report setting, where the number of RS resources to be reported is configured by the higher layer. Note that, the UE shall derive the CSI parameters other than resource indicator (i.e., CRI/SSBRI) conditioned on the reported resource indicator, where resource indicator k (k≥0) corresponds to the configured (k+1)-th entry of associated resource in the corresponding resource set for channel measurement.

Differential-based reporting method is used for the reporting of L1-RSRP and L1-SINR. For example, for L1-RSRP reporting, if the number of RS resources to be reported per report setting is configured to be one, the reported L1-RSRP value is defined by a 7-bit value in the range [−140, −44] dBm with 1 dB step size. If the number of measured RS resources to be reported per report setting is configured to be larger than one, the UE shall use differential L1-RSRP based reporting, where the largest measured value of L1-RSRP is quantized to a 7-bit value in the range [−140, −44] dBm with 1 dB step size, and the differential L1-RSRP is quantized to a 4-bit value. The differential L1-RSRP value is computed with 2 dB step size with a reference to the largest measured L1-RSRP value which is part of the same L1-RSRP reporting instance. The bitwidth for CRI, SSBRI, RSRP, and differential RSRP are provided in the following table.

| Field | Bitwidth |
|---|---|
| CRI | [log₂K^{CSI-RS}] |
| SSBRI | [log₂K^{SSB}] |
| RSRP | 7 |
| Differential RSRP | 4 |

where K^{CSI-RS} is the number of CSI-RS resources in the corresponding resource set, and K^{SSB} is the configured number of SS/PBCH blocks in the corresponding resource set for reporting ‘ssb-Index-RSRP’. The mapping order of CSI fields of one report for CRI/RSRP or SSBRI/RSRP reporting is provided in the following table.

| CSI report number | CSI fields |
|---|---|
| CSI report #n | CRI or SSBRI #1, if reported |
| | CRI or SSBRI #2, if reported |
| | CRI or SSBRI #3, if reported |
| | CRI or SSBRI #4, if reported |
| | RSRP #1, if reported |
| | Differential RSRP #2, if reported |
| | Differential RSRP #3, if reported |
| | Differential RSRP #4, if reported |

In the conventional beam reporting procedure, all reporting related configurations and settings are fully controlled by the network for obtaining the beam information and tracking the beam changes. However, as the beam information is not predictable at the network side, the network normally has to configure frequent beam reporting to obtain the timely beam information for data transmission, which may cause significant reporting and signaling overhead. To address this issue, we propose an event-triggered beam reporting method in this disclosure. Specifically, events for beam reporting are defined based on measurement quality variation monitoring among beams at different time instances/beam groups or for different channels/RSs. If any of the pre-defined events occurs, the UE would trigger beam reporting and report the corresponding measurement results to the network for beam update. As the event-triggered beam report is initiated by the UE on demand, the reporting latency and uplink reporting resource consumption can be greatly reduced compared with the conventional beam report method.

Similarly, in the conventional CSI report, all reporting related configurations/settings (such as the reporting type, reporting occasions, uplink reporting resources) are fully controlled by the NW for obtaining CSI information and tracking the CSI changes. The UE just needs to perform channel measurement and CSI report based on the NW configuration, regardless of whether the CSI has changed or not. However, since the CSI is not predictable at the NW side, the CSI report has to follow the timeline defined by the periodic, semi-persistent and aperiodic report settings. Thus, it may be difficult to get the CSI report in time in case of CSI changes. Besides, if there is no CSI changes, the repeated reporting of CSI information is an unnecessary waste of uplink resources. Therefore, in this document, we propose that the UE only reports CSI when there is obviously channel changes or when certain event is met. That is, the CSI report is initiated by the UE on demand and thus the uplink reporting overhead and latency can be greatly reduced.

### Embodiment #1: Event-Triggered Beam Report

With the existing beam reporting procedure, the network has to configure/trigger frequent beam reporting to obtain the timely best beam for data transmission, which may cause significant reporting and signaling overhead. Considering the UE has better knowledge on the channel variation, we propose an event-triggered beam report method in this embodiment to reduce the reporting latency and uplink reporting resource consumption.

In short, the UE can autonomously initiate beam report if the beam quality changes or a pre-determined event occurs, and thus the frequent beam report configuration/triggering is avoided. For notation simplicity, we define the ID or indicator of the best beam obtained by channel measurement at the present time as Q, the ID or indicator of the beam for given channels/RS (PDCCH/PDSCH/CSI-RS, etc.) as R, the ID or indicator of the best beam obtained by channel measurement at the last time as P. Here, the best beam may mean a beam selected from a RS resource set for channel measurement and associated with the largest measured L1-RSRP/L1-SINR/throughput or lowest hypothetical BLER. We also use ‘t−1’ and ‘t’ to represent the last time and the present time, respectively. The time gap between two consecutive measurements may be uniform in some embodiments while may be non-uniform in other embodiments and may be selected by the UE based on a pre-defined procedure. For example, in the last time instance, the best beam ID=2 and in the present time instance, the best beam ID=4. Then, at time instance “t−1” the measurement quality of P(t−1) represents the measurement quality of the previous best beam ID (i.e., beam ID=2), and the measurement quality of Q(t−1) represents the measurement quality of the current best beam ID (i.e., beam ID=4). In the present time instance (time t), the measurement quality of beam ID=2 would be described as the measurement quality of P(t) and measurement quality of beam ID=4 will be described as the measurement quality of Q(t).

For the RS resource set configured for channel measurement, the beam reporting may be triggered if any of (or some of) the following events occurs:
A pre-configured timer expires or has expired.
Upon configuration or reconfiguration of the RS resource set for channel measurement and/or the associated event-triggered reporting by upper layers
Q(t)≠R, i.e., the best beam at the present time is different from the beam for given channels/RS
Q(t)≠P(t−1), i.e., the best beam at the present time is different from the best beam at the last time
The measurement quality (L1-RSRP, or L1-SINR, or throughput, or hypothetical BLER) has changed more than a configurable value or threshold. The measurement quality variation assessed above is the different in measurement quality between the following two values.
1) the measurement quality of {R, Q(t) at the present time},
2) the measurement quality of {Q(t−1) at the last time, Q(t) at the present time},
3) the measurement quality of {P(t−1) at the last time, Q(t) at the present time},
4) the measurement quality of {P(t−1) at the last time, P(t) at the present time},
5) the measurement quality of {P(t) at the present time, Q(t) at the present time}.

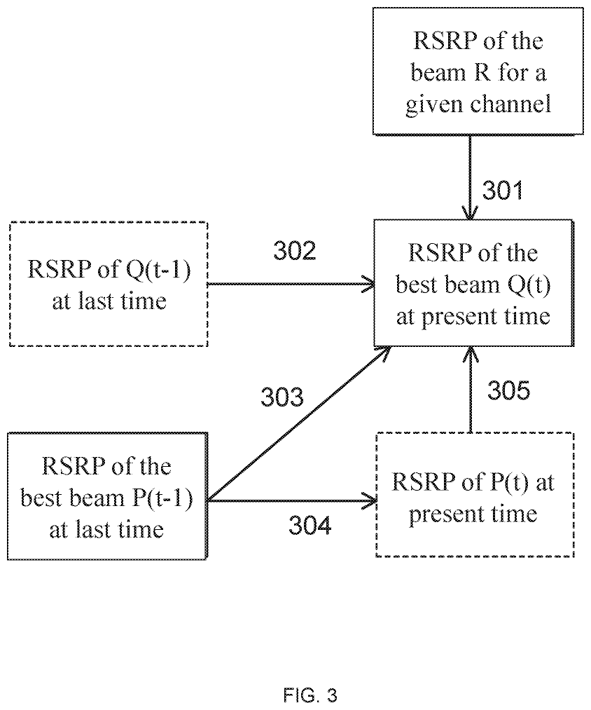

Taking RSRP as an example of measurement quality, FIG. 3 depicts how to determine the measurement quality variation, where the ends of the arrows represent the corresponding RSRPs that will be subtracted from each other. The above-enumerated options are depicted by arrows 301, 302, 303, 304 and 305 respectively. In case of beam reporting triggered by the above event(s), the UE reports the measurement results including at least one of the following parameters: beam indicator (CRI, SSBRI, etc.), measurement quality (L1-RSRP, L1-SINR, etc.), resource set indicator, the number of beams to be reported, measurement quality variation.

### Embodiment #2: Extension to Top-K Based Beam Reporting (K>1)

In embodiment 1, we only consider the measurement quality variation of the best beam (i.e., top-1 beam) at different time for the event-triggered beam reporting. However, in some scenarios, the measurement quality variation of multiple beams can be monitored and the beam reporting can be triggered if the variation of multiple beams exceeds a pre-defined threshold. For simplicity, we use the similar notations as defined in embodiment 1. Besides, at each measurement instance, K beams are selected and sorted based on their associated measurement quality (L1-RSRP, or L1-SINR, or throughput, or hypothetical BLER). For example, the top-1 beam (i.e., the best beam) means the beam selected from a RS resource set for channel measurement and associated with the largest measured L1-RSRP/L1-SINR/throughput or lowest hypothetical BLER, and the top-k beam is associated with the k-th largest measured L1-RSRP/L1-SINR/throughput or k-th lowest hypothetical BLER. A typical value of K may be K=2 to 8 beams.

On the basis of embodiment 1, if K (K is a positive integer) beams are considered for the measurement quality variation monitoring, the beam reporting may be triggered if any of (or some of) the following events occurs.
P(k, t−1)≠Q(k, t) for all k values (k=1, 2, . . . K), i.e., all the top-K beams at the present time are different from all top-K beams at the last time
P(k, t−1)≠Q(k, t) for one of the k value (k=1, 2, . . . K), i.e., the top-k beam at the present time is different from the top-k beam at the last time
The measurement quality (L1-RSRP, or L1-SINR, or throughput, or hypothetical BLER) has changed more than a configurable value or threshold. The measurement quality variation assessed here is the different in measurement quality between the following two values.
1) the measurement quality of {Q(k, t−1) at the last time, Q(k, t) at the present time}, for one of the k value, k=1, 2, . . . K
2) the measurement quality of {P(k, t−1) at the last time, Q(k, t) at the present time}, for one of the k value, k=1, 2, . . . K
3) the measurement quality of {P(k, t−1) at the last time, P(k, t) at the present time}, for one of the k value, k=1, 2, . . . K
4) the measurement quality of {P(k, t) at the present time, Q(k, t) at the present time}, for one of the k value, k=1, 2, . . . K
The measurement quality (L1-RSRP, or L1-SINR, or throughput, or hypothetical BLER) has changed more than a configurable value or threshold. The measurement quality variation assessed here is the different in average/total measurement quality of all K beams between the following two values.
a) {Q(t−1) at the last time, Q(t) at the present time}, where Q(t−1) and Q(t) represent the average/total measurement quality of all K beams at the last and present times, respectively.
b) {P(t−1) at the last time, P(t) at the present time}, where P(t−1) and P(t) represent the average/total measurement quality of all K beams at the last and present times, respectively.
c) {P(t−1) at the last time, Q(t) at the present time}
d) {P(t) at the present time, Q(t) at the present time}

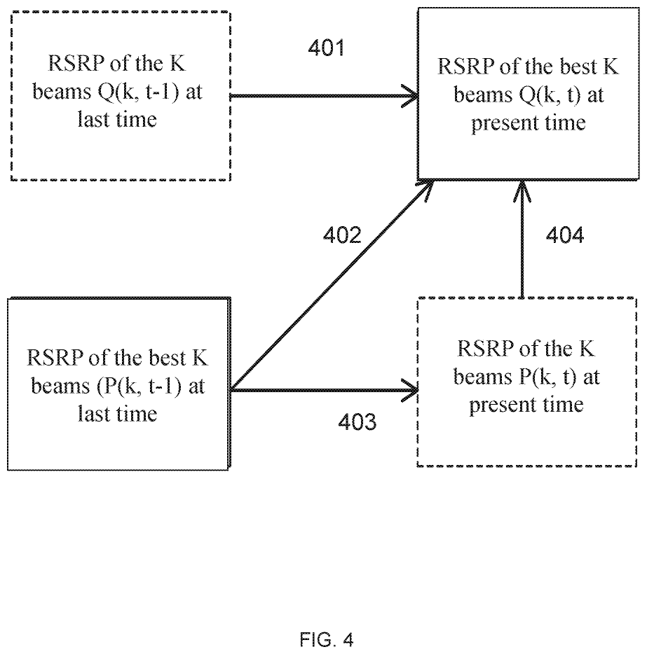

Taking RSRP as an example of measurement quality, FIG. 4 depicts how to determine the measurement quality variation, where the ends of the arrows represent the corresponding RSRPs that will be subtracted from each other. Arrows 401, 402, 403, 404 respectively represent the four listed scenarios above. Apart from the comparison with the beam for given channels/RS (i.e., R), embodiment 1 can be considered as a special case of embodiment 2 with K=1.

### Embodiment #3: Extension to Timer/Counter Based Beam Reporting

For the above embodiments, we only consider one-shot event-triggered beam reporting. That is, if the best beam changes or the measurement quality variation exceeds a pre-determined threshold, the beam reporting would be triggered. In this embodiment, which may be used together with the previous embodiments, we consider a more stringent condition based on timer/counter for the event-triggered beam reporting. Specifically, if the condition(s) defined in embodiment 1 or 2 is satisfied, it is recorded as an anomaly measurement sample, which would be reported from the physical layer to the medium access control (MAC) layer. The MAC layer maintains a relevant timer and a counter. Each time the MAC layer receives an anomaly measurement sample report, the timer is started or restarted, and the counter is increased by 1. If the timer expires, the UE resets the counter to 0, ensuring that the event-triggered beam reporting is based on successive anomaly measurement sample reports. If the counter reaches the specified maximum value during the running of the timer, a beam reporting event is considered to have occurred.

### Embodiment #4: Extension to Group Based Beam Reporting

In some scenarios such as a multiple transmission reception point (MTRP) based transmission scheme, group based beam reporting can be configured, which implies that different beams reported in the same group can be received simultaneously at the UE, or different beams reported for different groups can be received simultaneously at the UE. In the group based beam reporting, the UE shall indicate the RS resource set associated with the largest measured value of L1-RSRP/L1-SINR, and for each group, beam ID (CRI, SSBRI, etc.) of the indicated RS resource set is present first. In this embodiment, we consider the extension to MTRP or UE multi-panel scenario for event-triggered beam reporting.

For group based beam reporting, each channel state information CSI resource setting contains a configuration of a list of more than one RS resource sets, which are linked to the same beam reporting. The measurement quality variation and/or other conditions of the multiple RS resource sets should be monitored separately based on the rules defined in the above embodiments, with the same or different thresholds. For the multiple RS resource sets configured by the same resource setting, the event defined for the extension to group based beam reporting can be one or some of the following rules, where the conditions are defined in the above embodiments:
if the conditions associated with all RS resource sets are satisfied, the group based beam reporting is triggered and measurement results of all RS resource sets are reported.
if the condition associated with one or some (not all) RS resource set is satisfied
A) the group based beam reporting is triggered and measurement results of all RS resource sets are reported,
B) Or, the group based beam reporting is triggered and measurement results of these RS resource set are reported,
C) Or, the group based beam reporting is not triggered and no measurement results are reported.

### Embodiment #5: Beam Indication for UE Preference

As shown in the mapping order of CSI fields in this document, differential L1-RSRP/L1-SINR based reporting is adopted for the beam reporting and the beam ID associated with the largest measured value of L1-RSRP/L1-SINR is present first. In this embodiment, we propose the following two methods to report the UE preferred beam ID in the beam reporting, which is used as UE recommendation for potential beam switching.

One beam ID selected by the UE is present first, which can reflect the UE preference and may or may not be associated with the strongest L1-RSRP/L1-SINR. Alternatively, or in addition, all beam IDs to be reported are presented in the mapping order of CSI fields based on UE preference, regardless of their measured values of L1-RSRP/L1-SINR. Thus, the UE may need to indicate the location of the strongest L1-RSRP/L1-SINR for providing a reference for the differential reporting. The bitwidth of the location indicator may be ┌log₂ M┐ or ┌log₂ N┐, where ┌·┐ is the ceiling function, Nis the number of RS resources or resource groups to be reported per report setting, and M is the number of RS resources in the configured RS resource set (N and M are positive integers).

Alternatively, the beam ID associated with the largest measured value of L1-RSRP/L1-SINR is present first as legacy. The UE may also indicate a beam by reporting an additional indicator which can better reflect the UE preference. The bitwidth of the additional indicator may be ┌log₂ M┐ or ┌log₂ N┐ as defined above.

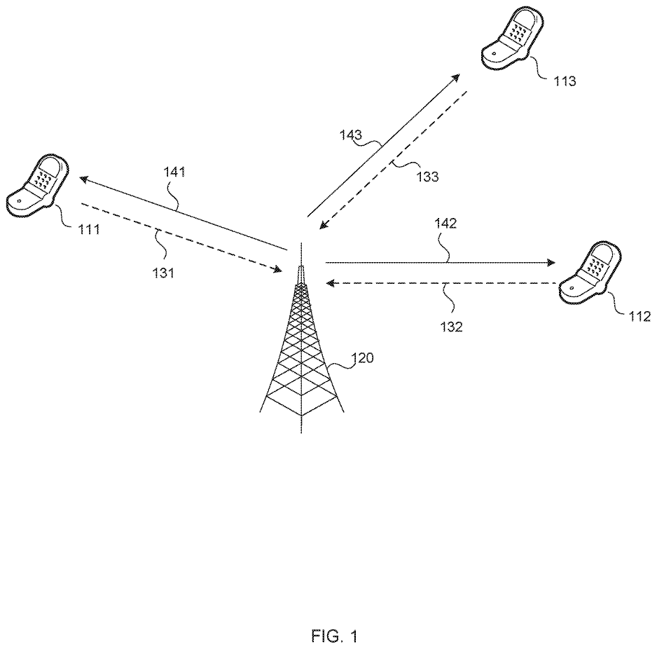

FIG. 1 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include downlink control information (DCI) or high layer signaling or downlink information. The UE may be, for example, a smartphone, a tablet, a mobile computer, a machine to machine (M2M) device, a terminal, a mobile device, an Internet of Things (IoT) device, and so on.

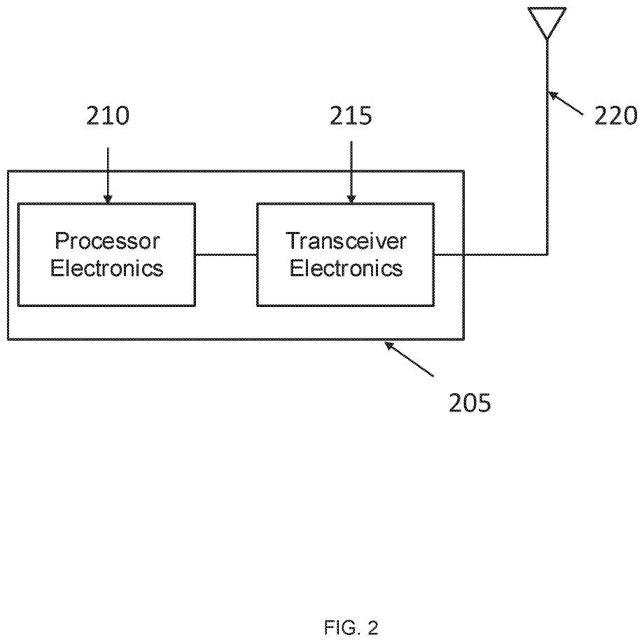

FIG. 2 is a block diagram representation of a portion of an apparatus based on some embodiments of the disclosed technology. An apparatus 205 such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

Some embodiments may preferably implement one or more of the following solutions, listed in clause-format. The following clauses are supported and further described in the embodiments above and throughout this document. As used in the clauses below and in the claims, a wireless device may be user equipment, mobile station, or any other wireless terminal including fixed nodes such as base stations. A network device includes a base station including a next generation Node B (gNB), enhanced Node B (eNB), or any other device that performs as a base station. The following listing of solutions may be implemented by some preferred embodiments.

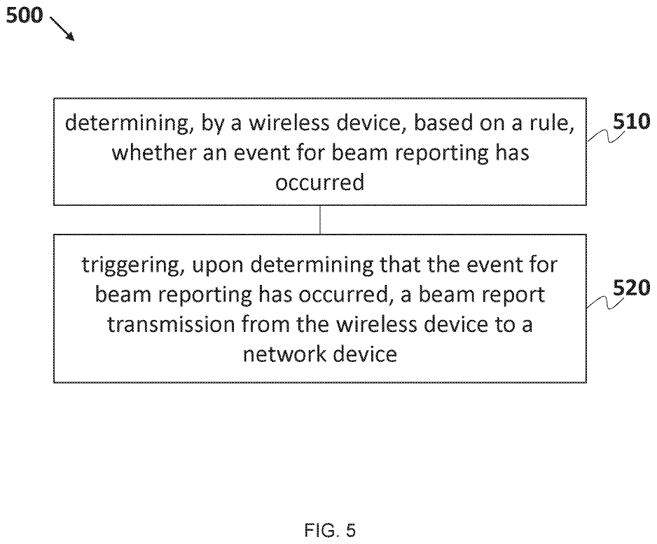

1. A method of wireless communication (e.g., method 500 depicted in FIG. 5), comprising: determining (510), by a wireless device, based on a rule, whether an event for beam reporting has occurred, and triggering (520), upon determining that the event for beam reporting has occurred, a beam report transmission from the wireless device to a network device. Embodiments 1 to 5 provide additional features and details of this method.

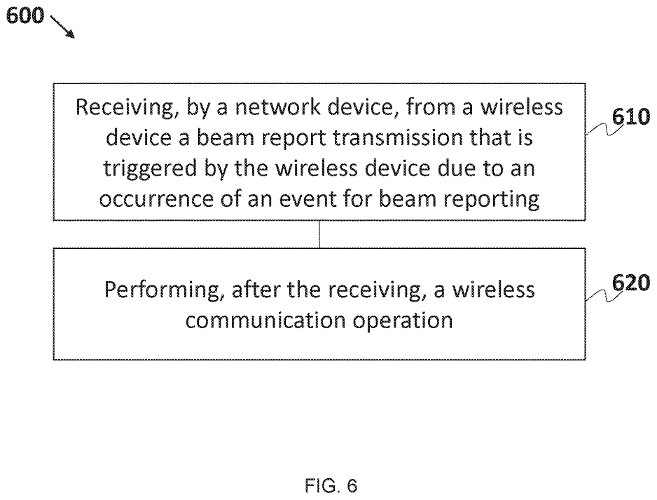

2. A method of wireless communication (e.g., method 600 depicted in FIG. 6), comprising: receiving (610), by a network device, a beam report transmission from a wireless device, wherein the beam report is determined by the wireless device based on a rule by determining whether an event for beam reporting has occurred, and performing (620) further wireless communication operation based on the beam report received from the wireless device. Embodiments 1 to 5 provide additional features and details of this method. In some embodiments, the further wireless communication operation includes, upon receiving, initiating a change in the beam used for transmission of data or control channels based on the received beam report. In some embodiments, the network device may make a determination about whether the received beam report transmission should be acted upon or should be ignored.

3. The method of any of solutions 1-2, wherein the rule specifies that the event for beam reporting has occurred in case that any one or more of following has occurred:
a beam at a present time is different from a beam at a last time;
a beam at a present time is different from a beam for a channel or a reference signal (RS);
a measurement quality variation is greater than a configured value or a threshold,
wherein the beam is determined based on a measurement quality associated with a RS resource set.

4. The method of solution 3, wherein the measurement quality variation comprises a difference in values of measurement qualities of (1) the beam for the channel or the reference signal, and (2) the beam associated with the RS resource set.

5. The method of solution 3, wherein the measurement quality variation comprises a difference in values of measurement qualities of (1) a beam at the last time, and (2) the beam at the present time, where the beam is determined based on the measurement quality associated with the RS resource set at the present time.

6. The method of solution 3, wherein the measurement quality variation comprises a difference in values of measurement qualities of (1) a beam associated with the RS resource set at the last time, and (2) a beam associated with the RS resource set at the present time.

7. The method of solution 3, wherein the measurement quality variation comprises a difference in values of measurement qualities of (1) a beam at the last time, and (2) the beam at the present time, where the beam is determined based on a measurement quality associated with the RS resource set at the last time.

8. The method of solution 3, wherein the measurement quality variation comprises a difference in values of measurement qualities of two beams at the present time, where the two beams are determined based on the measurement quality associated with the RS resource set at the last time and the present time, respectively.

9. The method of any of solutions 4-8, wherein the beam at the last time or the beam at the present time is a best beam associated with a largest measurement quality or a lowest measurement quality.

10. The method of any of solutions 3-9, wherein the measurement quality comprises at least one of the following: a layer 1 reference signal received power (L1-RSRP), an L1 signal to interference and noise ratio (L1-SINR), throughput, or a hypothetical block error rate (BLER).

11. The method of any of solutions 1-10, wherein the rule specifies that the event for beam reporting has occurred due to expiration of a timer.

12. The method of any of solutions 1-11, wherein the rule specifies that the event for beam reporting has occurred upon a configuration or a re-configuration of a reference signal resource set for channel measurement or an associated reporting by an upper layer.

13. The method of any of solutions 1-12, wherein the beam report transmission indicates at least one of a beam indicator, a measurement quality, a resource set indicator, a number of beams being reported or a measurement quality variation.

14. The method of solution 13, wherein the beam indicator comprises a channel state indication reference signal resource indicator (CRI) or a synchronization signal block resource indicator (SSBRI).

Embodiment 1 provides additional features and details of the above-listed solutions.

15. The method of any of solutions 1-14, wherein the rule is based on considering occurrence of a condition for K best beams, where K is a positive integer.

16. The method of solution 15, wherein the condition is that at least one of the K best beams at a present time is different from the K best beams at the last time, wherein the K best beams are determined based on a measurement quality associated with a reference signal (RS) resource set.

17. The method of solution 15, wherein the condition is that a measurement quality of one or more of the K best beams has changed more than a threshold between the last time and the present time.

18. The method of solution 15, wherein the condition is that the average or total measurement quality of all K best beams has changed more than a threshold between the last time and the present time.

19. The method of solution 15, wherein the condition for the K best beams comprises that a measurement quality variation between following two values is greater than a configured value or a threshold: an average measurement quality of the K previous best beams at the present time and an average measurement quality of the K current best beams at the present time; or a total measurement quality of the K previous best beams at the present time and a total measurement quality of the K current best beams at the present time.

20. The method of solution 15, wherein the condition for the K best beams comprises that a measurement quality variation between following two values is greater than a configured value or a threshold: an average measurement quality of a subset of the K current best beams at the last time and an average measurement quality of the subset of the K current best beams at the present time; or a total measurement quality of a subset of the K current best beams at the last time and a total measurement quality of the subset of the K current best beams at the present time.

21. The method of solution 15, wherein the condition for the K best beams comprises that a measurement quality variation between following two values is greater than a configured value or a threshold: an average measurement quality of a subset of the K previous best beams at the last time and an average measurement quality of the subset of the K current best beams at the present time; or a total measurement quality of a subset of the K previous best beams at the last time and a total measurement quality of the subset of the K current best beams at the present time.

22. The method of solution 15, wherein the condition for the K best beams comprises that a measurement quality variation between following two values is greater than a configured value or a threshold: an average measurement quality of a subset of the K previous best beams at the last time and an average measurement quality of the subset of the K previous best beams at the present time; or a total measurement quality of a subset of the K previous best beams at the last time and a total measurement quality of the subset of the K previous best beams at the present time.

23. The method of solution 15, wherein the condition for the K best beams comprises that a measurement quality variation between following two values is greater than a configured value or a threshold: an average measurement quality of a subset of the K previous best beams at the present time and an average measurement quality of the subset of the K current best beams at the present time; or a total measurement quality of a subset of the K previous best beams at the present time and a total measurement quality of the subset of the K current best beams at the present time.

24. The method of any of solutions 16-23, wherein the K best beam or the K current best beam or the K previous best beam correspond to K best beam associated with a largest measurement quality or a lowest measurement quality.

25. The method of any of solutions 15-24, wherein the largest measurement quality comprises a layer 1 reference signal received power (L1-RSRP), an L1 signal to interference and noise ratio (L1-SINR), throughput, or the lowest measurement quality comprises a hypothetical block error rate (BLER).

Embodiment 2 provides additional features and details of the above-listed solutions.

26. The method of any of solutions 1-25, wherein rule is based on counting a number of times a condition is met.

27. The method of solution 26, wherein the condition is determined within a period of time.

Embodiment 3 provides additional features and details of the above-listed solutions.

28. The method of any of solutions 1-27, wherein the rule is based on monitoring conditions associated with multiple reference signal resource sets.

29. The method of solution 28, wherein the rule specifies that, upon occurrence of the event for beam reporting, a group based beam reporting is triggered and measurement results for all the reference signal resource sets are reported in the beam report transmission

30. The method of solution 29, wherein the rule specifies that, upon occurrence of the event for beam reporting, a group based beam reporting is triggered and measurement results of reference signal resource sets used for determining occurrence of the event are reported in the beam report transmission.

31. The method of any of solutions 28-30, wherein the event for beam reporting comprises that a condition associated with one or more, but not all, reference signal resource sets is satisfied.

32. The method of any of solutions 28-30, wherein the event for beam reporting comprises that a condition associated with all reference signal resource sets is satisfied.

33. The method of any of solutions 1-32, wherein the beam report transmission indicates a selected beam and includes an identifier having a bit width ┌log_2 M┐ or ┌log_2 N┐, indicating a beam having a strongest channel measurement or a beam selected by the wireless device, wherein N is a number of reference signal resources or resource groups reported per report and M is a number of reference signal resources in a configured reference signal resource set.

Embodiments 4 and 5 provides additional features and details of the above-listed solutions. As previously noted, features and solutions listed under different embodiments may be combined together.

34. A wireless communication apparatus comprising one or more processors configured to perform a method according to any one of solutions 1-33.

35. A computer-readable medium storing code, the code, upon execution by one or more processors, causing the one or more processors to implement method recited in any of solutions 1-33.

It will be appreciated that the present document discloses techniques that can be embodied in various embodiments to allow a UE-triggered reporting of beam report information. Specifically, events for beam reporting are defined based on measurement quality variation monitoring among beams at different time instances/beam groups or for different channels/RSs. The beam reporting would be triggered if any of the pre-defined events occurs. As the event-triggered beam report is initiated by the UE on demand, the reporting latency and uplink reporting resource consumption can be greatly reduced compared with the conventional beam report method.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some implementations be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A method of wireless communication, comprising:
determining, by a wireless device, based on a rule, whether an event for beam reporting has occurred, and
triggering, upon determining that the event for beam reporting has occurred, a beam report transmission from the wireless device to a network device,
wherein the rule specifies that the event for beam reporting has occurred in case that any one or more of following has occurred:
a beam at a present time is different from a beam at a last time;
a beam at a present time is different from a beam for a channel or a reference signal (RS);
a measurement quality variation is greater than a configured value or a threshold,
wherein the beam is determined based on a measurement quality associated with a RS resource set.

2. The method of claim 1, wherein the rule is based on counting a number of times a condition is met.

3. The method of claim 2, wherein the condition is determined within a period of time.

4. The method of claim 1, wherein the measurement quality variation comprises a difference in values of:
measurement qualities of (1) the beam for the channel or the reference signal, and (2) the beam associated with the RS resource set.

5. The method of claim 1, wherein the measurement quality comprises a layer 1 reference signal received power (L1-RSRP).

6. The method of claim 1, wherein the beam report transmission indicates at least one of a beam indicator, a measurement quality, a resource set indicator, a number of beams being reported or a measurement quality variation.

7. The method of claim 6, wherein the beam indicator comprises a channel state indication reference signal resource indicator (CRI) or a synchronization signal block resource indicator (SSBRI).

8. The method of claim 1, wherein the rule is based on monitoring conditions associated with multiple reference signal resource sets.

9. The method of claim 8, wherein the rule specifies that, upon occurrence of the event for beam reporting, a group based beam reporting is triggered and measurement results for all the reference signal resource sets are reported in the beam report transmission.

10. The method of claim 9, wherein the event for beam reporting comprises that a condition associated with one or more, but not all, reference signal resource sets is satisfied.

11. A method of wireless communication, comprising:
receiving, by a network device, a beam report transmission from a wireless device, wherein the beam report is determined by the wireless device based on a rule by determining whether an event for beam reporting has occurred, and
performing further wireless communication operation based on the beam report received from the wireless device,
wherein the rule specifies that the event for beam reporting has occurred in case that any one or more of following has occurred:
a beam at a present time is different from a beam at a last time;
a beam at a present time is different from a beam for a channel or a reference signal (RS);
a measurement quality variation is greater than a configured value or a threshold,
wherein the beam is determined based on a measurement quality associated with a RS resource set.

12. The method of claim 11, wherein the measurement quality variation comprises a difference in values of:
measurement qualities of (1) the beam for the channel or the reference signal, and (2) the beam associated with the RS resource set.

13. The method of claim 11, wherein the measurement quality comprises a layer 1 reference signal received power (L1-RSRP).

14. The method of claim 11, wherein the beam report transmission indicates at least one of a beam indicator, a measurement quality, a resource set indicator, a number of beams being reported or a measurement quality variation.

15. The method of claim 14, wherein the beam indicator comprises a channel state indication reference signal resource indicator (CRI) or a synchronization signal block resource indicator (SSBRI).

16. The method of claim 11, wherein the rule is based on counting a number of times a condition is met.

17. The method of claim 16, wherein the condition is determined within a period of time.

18. The method of claim 11, wherein the rule is based on monitoring conditions associated with multiple reference signal resource sets.

19. A wireless communication apparatus comprising one or more processors configured to perform a method, comprising:
determining, by a wireless device, based on a rule, whether an event for beam reporting has occurred, and
triggering, upon determining that the event for beam reporting has occurred, a beam report transmission from the wireless device to a network device,
wherein the rule specifies that the event for beam reporting has occurred in case that any one or more of following has occurred:
a beam at a present time is different from a beam at a last time;
a beam at a present time is different from a beam for a channel or a reference signal (RS);
a measurement quality variation is greater than a configured value or a threshold,
wherein the beam is determined based on a measurement quality associated with a RS resource set.

20. The wireless communication apparatus of claim 19, wherein the measurement quality variation comprises a difference in values of:
measurement qualities of (1) the beam for the channel or the reference signal, and (2) the beam associated with the RS resource set.
